(19) United States
(12) Patent Application Publication
(10) Pub. No.: US 2022/0017239 A1
(43) Pub. Date: Jan. 20, 2022

(54) METHODS AND SYSTEMS FOR ORBIT ESTIMATION OF A SATELLITE

(71) Applicant: THE AEROSPACE CORPORATION, El Segundo, CA (US)

(72) Inventor: Derek Chen, Torrance, CA (US)

(21) Appl. No.: 16/932,418

(22) Filed: Jul. 17, 2020

(51) Int. Cl. B64G 1/24; G06K 9/00; B64G 1/36

(52) U.S. Cl. CPC B64G 1/242; B64G 1/244; B64G 1/365; G06K 9/0063

(57) ABSTRACT

Disclosed herein are systems and methods for estimating an orbit of a satellite using only images captured by an onboard camera of the satellite. One of the disclosed methods includes: capturing a plurality of images using an onboard camera of the satellite; determining the trajectory, loop closure metrics, and the relative geographic position of the satellite using the plurality of images captured by the onboard camera; and estimating the orbit of the satellite based at least on the determined trajectory, loop closure metrics, and the relative geographic position of the satellite.

### FIELD

Various aspects of the disclosure relate to orbit determination, and in one aspect but not by way of limitation, to estimating the orbit of a satellite.

### BACKGROUND

Orbit determination of satellites and celestial objects has been heavily studied for a couple of centuries. A modern application of the orbit determination studies is the orbit estimation of artificial (e.g., manmade) satellites, which has recently become very important due to explosion of the number of artificial satellites orbiting the Earth. The accurate estimation the state and state uncertainty data of a satellite is important for many reasons. First, without an accurate estimate of a satellite's orbit, there would be no way to properly calculate the rate of orbit decay and thus the orbital life of the satellite. More importantly, without an accurate orbit estimate, assessments of collision probabilities with other satellites would not be possible. Currently, there are thousands of artificial satellites and hundreds of thousands of space debris in a low Earth orbit (LEO), and commercial activities will likely add thousands more satellites in the near future. These artificial satellites can be a threat to each other if their orbits are not properly monitored and maintained. Additionally, space debris can pose a threat to these satellites if orbital maintenance (e.g., station keeping) and maneuvers of these satellites cannot be performed. However, a prerequisite for orbital maintenance and maneuvers is the accurate estimation of the state and state uncertainty data of the satellite. Accordingly, there is a need for an accurate satellite orbit determination system.

### SUMMARY

Disclosed herein are systems and methods for estimating the orbit of a satellite using only on-board instruments of the satellite. One of the methods for estimating the orbit of a satellite includes: capturing a plurality of images from a camera on the satellite; determining a relative motion of the satellite by performing visual odometry on a first set of one or more images from the plurality of captured images; generating loop closure measurements by comparing a second set of images from the plurality of captured images; determining a relative geographic position of the satellite by detecting geographic features of a third set of one or more images from the plurality of captured images; and estimating, using an estimator, the orbit of the satellite based at least on one or more the determined relative motion, orbital period, and the relative geographic position of the satellite.

The method can estimate the orbit of the satellite using an estimator such as, but not limited to, a least square minimizing algorithm, a batch estimation algorithm (e.g., Graph-SLAM), a Kalman filter algorithm, or other estimation algorithms.

Generating loop closure measurements can include determining one or more of an orbital revisit event and a time duration for the satellite to complete a full loop around the Earth based on image analysis of the second set of images. The second set of images can be a first image taken over a geographic region and a second image taken over the same geographic region at a later time (e.g., 120 minutes later).

Performing visual odometry can include performing structure from motion analysis on consecutives images of the first set of one or more images to determine the trajectory of the satellite.

In some embodiments, determining the relative geographic position can include clustering special features on the third set of one or more images to perform consistency check and omit outlying features. The map matching module can also cluster and compare special features on the third set of one or more images with known features of geo-registered images.

One of the systems for estimating an orbit of a satellite includes: an onboard camera of the satellite configured to capture a plurality of images; a visual odometry module configured to determine a trajectory of the satellite by performing visual odometry on a first set of one or more images captured by the onboard camera; an orbital revisit module configured to determine loop closure metrics; a map matching module configured to determine a relative geographic position of the satellite by detecting geographic features of a third set of one or more images from the plurality of captured images; and an orbit estimating module configured to estimate the orbit of the satellite based at least on one or more of the determined trajectory, loop closure metrics, and the relative geographic position of the satellite. The plurality of images can be captured at nadir or off-nadir with the use of various image adjustment techniques.

A second method for estimating an orbit of a satellite is also disclosed. The second method includes: capturing a plurality of images using an onboard camera of the satellite; determining a trajectory, loop closure metrics, and a relative geographic position of the satellite using the plurality of images captured by the onboard camera; and estimating the orbit of the satellite based at least on one or more of the determined trajectory, orbital period, and the relative geographic position of the satellite.

A third method for generating a 3D reconstruction map is also disclosed. The third method includes: obtaining, using a simultaneous localization and mapping (SLAM) algorithm, relative motion data from a plurality of images captured from an onboard camera of a satellite; map matching features of the plurality of captured images with features of geo-registered images to determine one or more geographic anchor points; detecting a loop closure event based on features matching of two sets of images indicating that the satellite passed over a generally same geographic location and generating relative motion data for each of the two set of images; and generating the 3D reconstruction map based at least on the relative motion data from the SLAM algorithm, one or more geographic anchor points, and relative motion data of the two sets of images of the loop closure event.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 illustrates a diagram illustrating an orbit determination system in accordance with some embodiments of the present disclosure.

FIG. 2A shows two images illustrating the feature generating, clustering, and matching process of a region in accordance with some embodiments of the present disclosure.

FIG. 2B illustrates the same image in FIG. 2A after a feature clustering and consistency check process in accordance with some embodiments of the present disclosure.

FIG. 3A shows two images illustrating the feature generating, clustering, and matching process of a region in accordance with some embodiments of the present disclosure.

FIG. 3B illustrates the same image in FIG. 3A after a feature clustering and consistency check process in accordance with some embodiments of the present disclosure.

FIG. 4A is an image with special features generated by a features extractor in accordance with some embodiments of the present disclosure.

FIG. 4B is an image illustrating an estimated trajectory using a SLAM algorithm in accordance with some embodiments of the present disclosure.

FIG. 4C is an image illustrating an orbital revisit detection process in accordance with some embodiments of the present disclosure.

FIG. 5 is a chart of an orbit determination process in accordance with some embodiments of the present disclosure.

FIG. 6 is a block diagram illustrating software and hardware components of an orbit determination system in accordance with some embodiments of the present disclosure.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

### Overview

Conventional approaches for Earth orbit (e.g., low, mid, high) determination include using ground-based tracking system, GPS, and cooperative ranging. Ground-based tracking systems such as satellite laser tracking stations, Doppler system, and optical telescope can be used to gather positional data of satellites for orbit determination. However, ground-based tracking systems can easily be overwhelmed by the amount of satellites that need to be tracked. Further, certain ground-based tracking processes (e.g., laser) can be obscured by weather and other natural anomalies.

GPS tracking and cooperative ranging systems face similar hurdles in that they heavily rely on other systems outside the control of the satellite and/or require additional onboard equipment. For example, satellite with a GPS tracking system require an onboard space-grade GPS receiver and supporting peripherals (e.g., power system, battery) that would add to the already stringent SWaP (size, weight and power) constraint of a small satellite such as a CubeSat. Similarly, cooperative ranging systems rely on data from other satellites, which are not always reliable and also require additional onboard equipment to manage and tabulate. Both the GPS and cooperative ranging systems have inherent risks and vulnerabilities that can cause system downtime, which can make them unreliable. Thus, autonomous orbit determination system is highly preferred.

The disclosed orbit determination system and method (hereinafter can be referred to collectively as the orbit determination system) is a self-supporting system with minimal requirement for additional onboard equipment that is not already typically present in a small satellite. For example, the orbit determination system requires a camera, a memory, and a processor, all of which are typical components of a small satellite. The camera can be a low-cost monocular camera, and the processor can be a standard central processing unit (CPU), a graphical processing unit (GPU), or a combination of both.

The orbit determination system uses an onboard camera to capture a plurality of images at various intervals (e.g., regular, irregular). The camera can be pointed at nadir during the image capturing process. The images are then analyzed to extract trajectory and positional data, which are then further processed by an estimator to obtain the final trajectory estimate and uncertainty. The estimator can employ a least square method, a sequential-batch least squares method, the sequential filter (e.g., Kalman filter) method, batch estimation (e.g., graph-SLAM (simultaneous localization and mapping)) method, or estimation method. Initial trajectory data (e.g., directional and velocity vectors) can be extracted from a plurality of consecutive images using visual odometry methods such as, but not limited to, structure from motion or visual simultaneous localization and mapping.

In some embodiments, the orbit determination system can use a Bayesian network to model the satellite orbit. The Bayesian network is a batch process that takes inputs from several estimators such as, but not limited to, image-based location estimator, an initial trajectory and/or velocity estimator, and an orbital revisiting estimator (e.g., closed orbital loop estimation). The image-based location estimator can generate and/or identify ORB features in images captured from a satellite and match them with ORB features in geo-registered images. The initial trajectory and velocity estimator can use the same ORB features as inputs. The orbital revisiting (or loop closure) estimator provide loop closure measurements necessary for the final orbit estimation process to estimate the orbit of the satellite.

The orbit determination system can determine the satellite's relative geographic position by map matching captured images with geo-registered images (using a map matching module), which are images having known geographic features and corresponding anchoring position(s) and/or elevation of the satellite. The map matching module can include a database of geo-registered images, which can be tailored to contain geo-registered images of geographic regions of the expected orbit (and margin of error orbits) of the satellite to reduce the potential search space while the map matching process is performed. Geographic features can include coastlines, coastal features (e.g., harbor, bay), man-made objects, natural objects, bodies of water (e.g., lakes, rivers), etc. The geographic anchor point of an image can be associated with one or more geographic features. For example, the geographic anchor point can be the center of several geographic features of an image.

The disclosed orbit determination system does not require external input—data from external sources such as positional data from ground-based laser tracking stations or space-based GPS satellites. All of the data required for orbit determination can be extracted from the images captured by the onboard camera of the satellite. Specifically, the initial trajectory and velocity data can be extracted from consecutively captured images using visual odometry. The orbital period can be extracted from images captured over the same geographic region after a time delay. Lastly, the relative geographic position (e.g., geographic anchors) can be determined by map matching features of captured images with features of previously geo-registered images. These data are then fed into an estimator to generate a final trajectory estimate and the trajectory uncertainty value(s) of the satellite.

### Orbit Determination

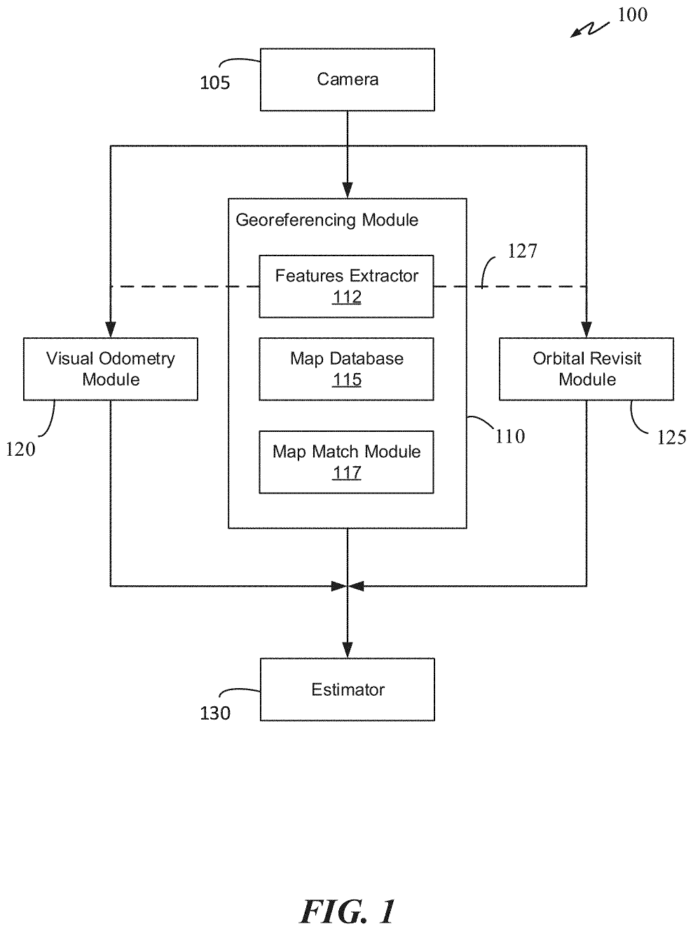

FIG. 1 is a diagram illustrating the components of the orbit determination (OD) system 100 in accordance with some embodiments of the present disclosure. OD system 100 includes a camera 105, a georeferencing module 110, a visual odometry module 120, an orbital revisit module 125, and an estimator 130, all of which are onboard of a satellite (e.g., CubeSat). Camera 105 can be a monocular camera with the optical axis pointed at or off nadir. Camera 105 can automatically capture images continuously or intermittently. The capture images can be stored in a database (not shown) for later retrieval and processing. As shown, OD system 100 includes three image analysis modules, each of which is configured to preprocess one or more captured images to obtain relative motion data, georeferenced position(s), and loop closure data from the one or more captured images. Georeferencing module 110 includes an image features extractor 112, a map database 115, and a map matching module 117.

Image features extractor 112 can include one or more feature extractors configured to extract features such as, but not limited to, ORB, SURF, and SIFT features. ORB stands for oriented FAST (Feature from Accelerated Segment Test) and rotated BRIEF (Binary Robust Independent Elementary Features). The ORB feature extractor can include two components. The first is the FAST-based feature detection algorithm and the second is a BRIEF feature descriptor. Given an image, the FAST feature detection algorithm detects feature points (e.g., keypoints) and calculates the orientation of the feature points that are rotation invariant. On a high level, the BRIEF descriptor transforms all of the FAST feature points into a binary feature vector to represent an object. An image can have many ORB features and binary feature vectors. Feature extractor 112 can also be configured to extract other types of feature such as, but not limited to, SIFT (scale-invariant feature) and SURF (speeded up robust features).

In some embodiments, image feature extractor 112 is configured to extract features that can be used by georeferencing module 110 and visual odometry module 120. For example, feature extractor 112 can extract ORB features that can be used to match features of captured images with features of stored images of known locations (e.g., georeferenced images). Map matching features of stored images are pre-extracted and referenced to known geographic features or location. For instance, image feature extractor 112 can process the incoming images and extracts microscopic or macroscopic features for map matching. Microscopic features include features similar to ORB, SIFT, and SURF. Macroscopic features entail higher level processing of the imagery to identify larger-scale features such as mountain ranges, lakes, coastlines and other geospatial features/landmarks extracted either through image processing or machine learning approaches.

As mentioned, image features extractor 112 can implement an ORB features extractor to recognize features and/or objects in the image, which can then be used by: map matching module 117 to conduct features/object matching for georeferencing and consistency check; visual odometry module 120 to determine relative motion (e.g., shape of a trajectory); and orbital revisit module 125 to generate loop closure metrics (e.g., loop completion detection,). In other words, outputs from feature extractor 112 can be used by visual module 120 and orbital revisit module 125 as denoted by line 127.

On a high level, visual odometry (VO) module 120 is configured to use the features outputted by feature extractor 112 to determine the relative motion of the satellite. For instance, VO module 120 determines the relative motion of the satellite based on the analysis of the extracted features of related images. One or more of the extracted features of each image can be tracked across frames to estimate the relative motion (e.g., local trajectory) of the satellite and to reconstruct the local 3D environment in which the satellite is traveling.

Map matching module 117 can include features and/or objects matching algorithm that is configured to match features of one image (e.g., images from the satellite onboard camera) with features on another image(s) (e.g., geo-registered images). The geo-registered images can be images in map database 115, which can be an extensive database of geo-registered images. Each geo-registered image can contain known geographic anchor points of the image source (e.g., the camera's location). Geographic anchor points can include geographic reference coordinates in accordance with the WGS (World Geodetic System) standard. Each geo-registered image can also contain altitude related e.g., elevation) metadata of the image source, which can be used to enhance and/or corroborate the WGS geographic reference coordinates. Map database 115 can include geo-registered images that are within one or more expected orbits and additional orbits within a certain margin of error for each expected orbit. In this way, map database 115 does not need to include all geo-registered images. Additionally, by limiting the number of geo-registered images in map database 115, the search space of the features/map matching process can be reduced.

Map matching module 117 can be configured to cluster and match recognized features and/or objects (from extractors 112) of an input image and with features and/or objects of one or more geo-registered images. Map matching module 117 can include a feature clustering algorithm to match clustered feature(s) of the input image with features of geo-registered image and to perform consistency check before accepting the features of the input image(s). Once a good match is found and the consistency check is valid, the satellite's geographic anchor points can be assigned to the geographic reference coordinates of the matched geo-registered image(s). In this way, the satellite's geographic anchor points can be estimated with respect to the global frame.

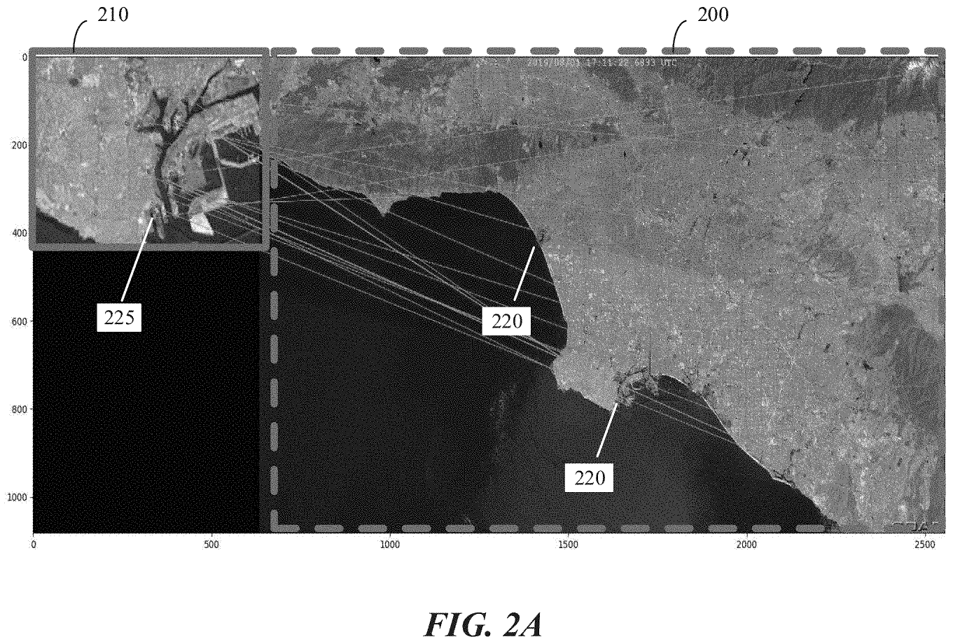

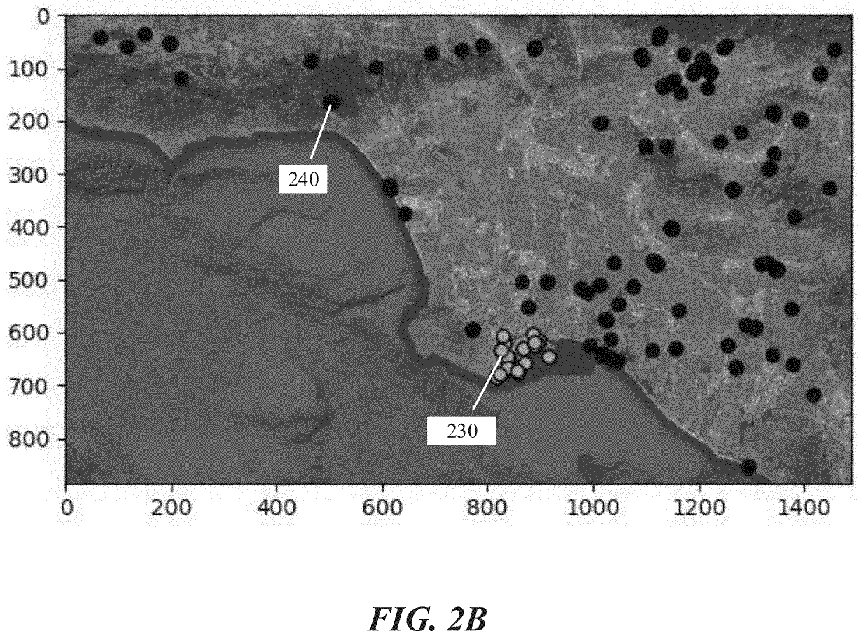

FIGS. 2A-B will now be discussed in conjunction with FIG. 1. Image 200 of FIG. 2A is an example geo-registered image from an image database, which can be stored in a local memory of the satellite. Geo-registered image 200 can include pre-extracted features 220, which can be local image features (e.g., ORB, SURF) and/or macroscopic features such as coastlines, mountains, lakes, and man-made structures such as buildings.

Image 210 is an example image captured by the satellite's camera. Once image 210 is captured, features extraction is performed by features extractor 112 to extract features from image 210. Similar to the geo-registered images, extracted features can include local image features (e.g., ORB) and/or macroscopic features (e.g., coastlines, mountains, buildings). As shown, features 225 are extracted from image 210. Next, map matching module 117 can use an image correspondence algorithm to correlate similar features from images 200 and 210 to match a portion of image 210 to a portion of image 200.

FIG. 2B illustrates the result of the features clustering algorithm where features are clustered with features found in nearby frames and/or in geo-registered images. From feature correspondence, an image similar to 210 may be shifted to a larger database such as 200. As such, a dot similar to 230 is generated denoting the shifted match. By corresponding multiple preceding or subsequent images, one is able to generate a series of matches. Since it is physically impossible to jump large gaps, by clustering where the matches are located across a series of frames, one is able to reject outlier matches such as 240. images and/or with feature on preceding and/or subsequent images. If the clustered features 230 are found in other images, then it can be kept for use in the orbit estimation process. The clustering process is configured to root out outlying features that are not consistent with features on geo-registered images and/or with features on preceding and/or subsequent images. Outlying features can be features that do not consistently appear in consecutive images (e.g., frame to frame). If a feature(s) is found in neighboring images (e.g., close in time) and/or geo-registered images, the feature can be classified as valid. In other words, the feature passes the consistency check. In contrast, if the feature is not found in preceding and/or subsequent images, then the feature fails the consistency check and is omitted. Features that pass the consistency check can be included in the geo-anchoring and orbit estimation processes.

In FIG. 2B, features 240 are features that do not match with features in nearby frames and/or geo-registered images can be discarded. Once the features are clustered and the consistency checked, the satellite's geographic anchor points or positions can be estimated and/or anchor to the corresponding geographic reference coordinates of a geo-registered image having the same features. This helps anchor the local estimation(s) (from the visual odometry module) to a global frame.

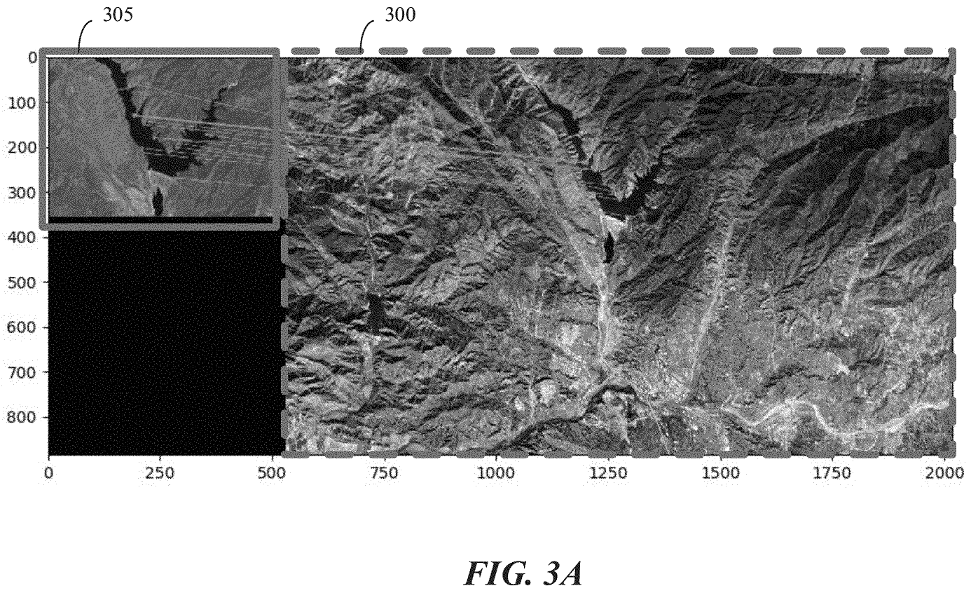

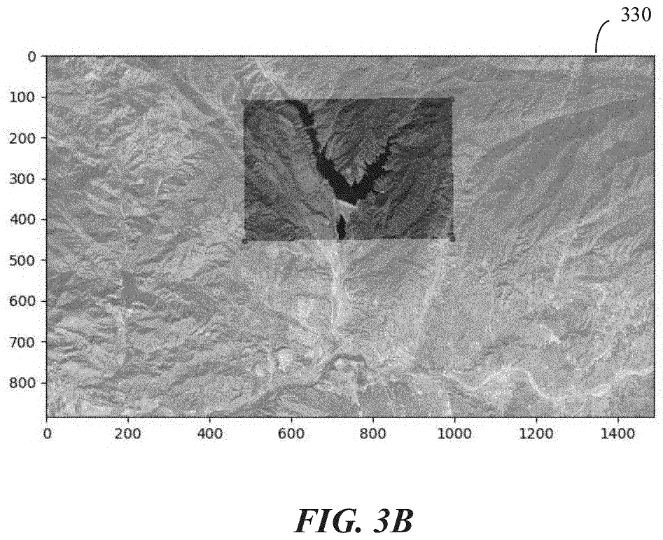

In another example, FIG. 3A shows an image from an image database (e.g., Google Map) reference in image 300 and a simulated image 305 of the image incoming from the satellite. Post feature extraction, correspondence, and outlier rejection, a match is found between the incoming image and the database image, yielding the correspondence shown in FIG. 3B. In some embodiments, georeferencing module 110 can perform features comparison and matching between image 300 and image 305, which is an image preceding or subsequent image in time to geo-registered image 300. Alternatively, the feature comparison and matching process can be done as an image post processing step. FIG. 3B is a picture illustrating the result of the feature clustering and/or matching processes. As shown, the geographic anchor points determination process provides a prediction of the satellite's anchoring points that are matched to the geographic reference coordinates of one or more nearby images and/or one or more geo-registered images. Once the features comparison and matching process is completed, one or more geo-registered images can be used to estimate/predict the geographic anchor points of the satellite when the captured image(s) (e.g., image 300) was taken.

As previously alluded to, once features on the satellite's image are matched to features on a geo-registered image, the satellite's geographic anchor points or positions can be assigned to match the corresponding geographic reference coordinates of the geo-registered image. This helps anchor the local estimation on a global frame.

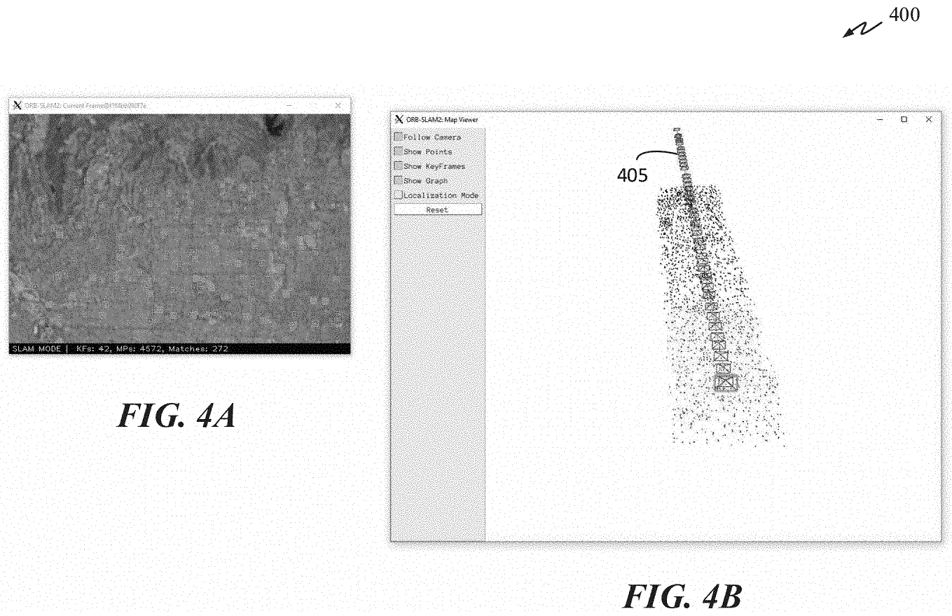

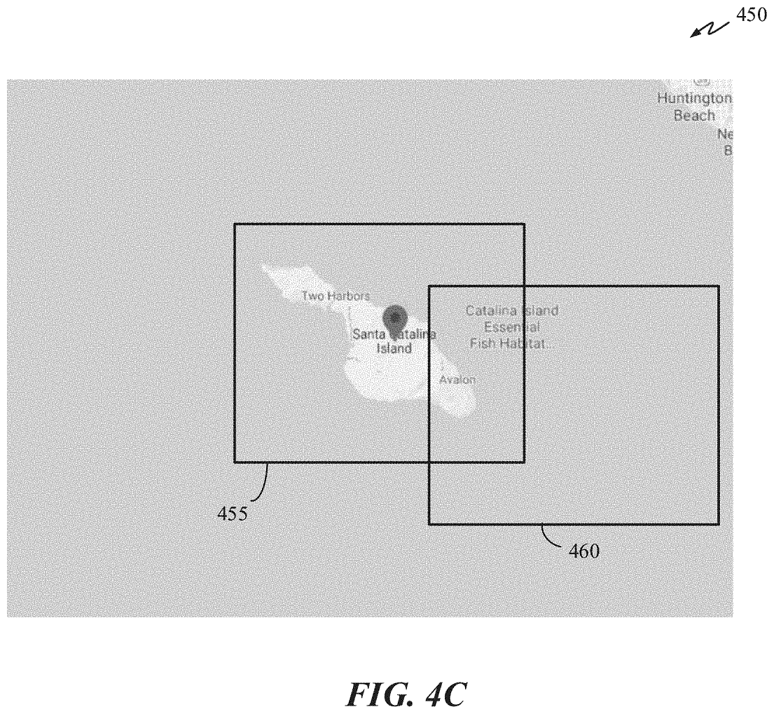

FIGS. 4A-4B graphically illustrate a visual odometry process 400 in accordance with some embodiments of the present disclosure. FIG. 4A illustrates an image, captured by camera 105, with ORB features (other features can also be extracted). The ORB features can be extracted using feature extractor 112. In some embodiments, feature extractor 112 can also extract SIFT, SURF, or other user defined features. FIG. 4B is a visual illustration of the visual odometry (VO) process using special features (e.g., ORB) of multiple consecutively captured images to generate an estimate of the local trajectory—relative motion of the satellite. In the actual VO process performed by VO module 120, the visual illustration shown in FIG. 4B is omitted (but can be done). Based on the ORB features from the consecutive images, the VO module 120 can estimate the relative motion of the satellite. VO module 120 can optionally reconstruct the local 3D environment from the consecutive 2D images using estimation algorithm such as, but not limited to, SLAM. As shown, within the local 3D environment, the VO algorithm can estimate the trajectory 405 of the satellite. In addition to the estimated trajectory, using timestamps and other image metadata, a velocity vector of the satellite can also be determined.

FIG. 4C illustrates an orbital revisit detection process 450 of orbital revisit module 125 in accordance with some embodiments of the present disclosure. In some embodiments, process 450 is configured to use a combination of the visual odometry and map matching processes to detect an orbital revisit. For example, in a first time instance, image 455 is captured, which is then analyzed and processed by VO module 120 and map matching module 117 to capture relative motion data and geographic anchoring data, respectively. In a second time instance (subsequent to the first time instance), image 460 is captured by the satellite. Similar to image 455, image 460 is then processed by VO module 120 and map matching module 117. Based on comparisons of one or more of local, macroscopic features (e.g., coastlines), and the geographic anchor point(s) of images 455 and 460, map matching module 117 can determine that the satellite has revisited the same general area (in this case Catalina island) even though only a portion of Catalina island is captured by the second image. Once orbital revisit module 125 determines an orbital revisit even has occurred, the relative motion data collected for images 455 and 460 are sent to estimator 130 for orbit estimation of the satellite.

Referring again to FIG. 1, estimator 130 can be configured to output the state of the satellite either in the Keplerian or cartesian coordinate frame along with other parameters such as drag or solar radiation pressure (SRP) coefficients based on outputs of the VO module. A cartesian output can consist of a state vector including position and velocity. A Keplerian output includes at least six orbital elements to describe the satellite's orbit. The output orbital elements can include the following elements: semi-major axis, which defines the size of the orbit; eccentricity, which defines the shape of the orbit; inclination, which defines the orientation of the orbit with respect to the Earth equator; the argument of perigee; the right ascension of the ascension node; and the true/mean anomaly. The argument of perigee defines where the low point, perigee, of the orbit is with respect to the Earth's surface. The right ascension defines the location of the ascending and descending orbit locations with respect to the Earth's equatorial plane. The true/mean anomaly defines where the satellite is within the orbit with respect to perigee. In some embodiments, estimator 130 can also output uncertainty or confidence value for one or more the orbital elements.

Estimator 130 can employ a graph-based SLAM method to estimate the orbit of the satellite based at least on inputs from VO module 120, georeferencing module 110, and orbital revisit module 125. Based on those inputs, estimator 130 can output the most likely trajectory of the satellite. VO module 120 can at least provide a local estimation of the satellite trajectory and velocity. Georeferencing module 110 can provide at least the global anchor point(s), and orbital revisit module 125 can provide at least loop closure detection and relative motion data of two different time instances as the satellite revisit the same general area. This enables estimator 130 to constrain the satellite orbit estimation based on relative motion data between those two positional states of the satellite.

In some embodiments, estimator 130 can be configured to use a least-square error minimization method to estimate the orbit of the satellite. The least-square error minimization method can include a non-linear least square minimization method or an iteratively reweighted least square method. It should be noted that estimator 130 is not limited to the least-square minimization method, estimator 130 can also use other estimation methods.

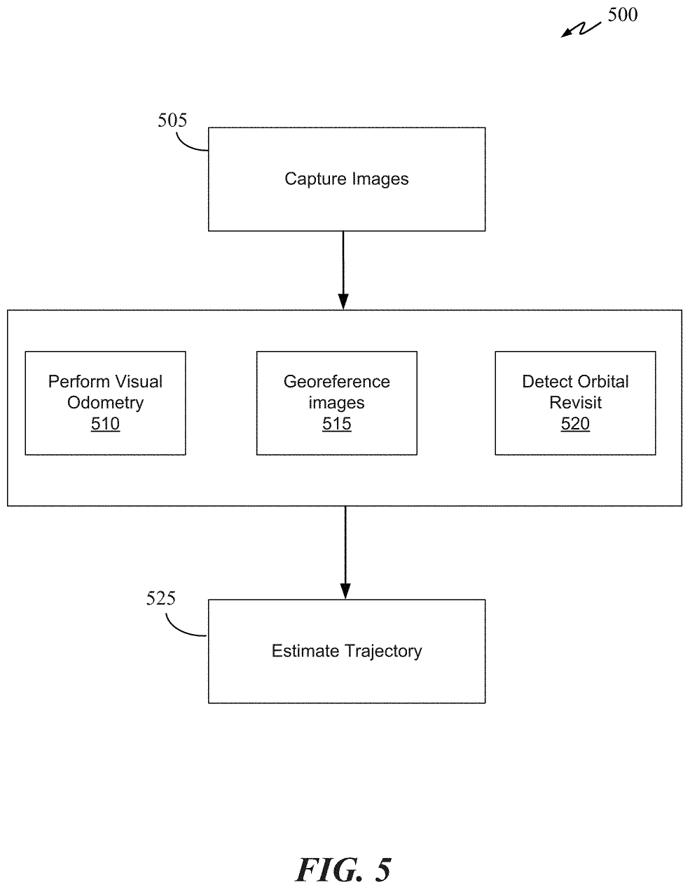

FIG. 5 is a block diagram illustrating an orbit determination process 500 in accordance with embodiments of the present disclosure. Process 500 starts at 505 where the satellite (e.g., CubeSat) captures a plurality of images using an onboard camera. The optical axis of the onboard camera can be pointed at nadir. Alternatively, image compensation can be performed if the optical axis is off nadir. At 510, visual odometry can be performed on the captured images to determine relative motion data by first extract features (e.g., image features, ORB features, landmarks) using features extractor 112 of georeferencing module 110. Features extractor 112 can generate ORB features such as features 220 and 225 as shown in FIG. 2A. Orb features of consecutive images/frames are then used to perform visual odometry. For example, the visual odometry process 510 can also include performing visual odometry on consecutive images to estimate the trajectory of the satellite using a SLAM algorithm as described with respect to FIGS. 4A-B.

At 515, the ORB features can be used by georeferencing module 110 to perform features clustering to root out outlying features. Features that matched up between captured and stored images are then used to perform features mapping, which ultimately determines the geographic anchor point(s) of the satellite at the time the captured images were taken (see FIGS. 2-3).

At 520, orbital revisit can be detected (using orbital revisit module 125) by analyzing features (e.g., local and macro features) of time-lapsed images to determine when the satellite has passed over the same geographic area. For example, orbital revisit module 125 can identify images taken at approximately the same orbital location at different times (e.g., several hours apart) to determine that the loop has been closed or an orbital revisit event has occurred by comparing the features of images captured at different times. By recognizing that two images are captured over the same general area, a loop closure event can be determined and relative motion data between the first and second instances can be used to further constrain the orbit calculations performed by estimator 130. An orbital revisit event occurs when time-lapse images taken by the satellite show that the satellite has revisited the same general area based on features extracted from the time-lapse images. At 525, the initial trajectory of the satellite can be estimated using results generated at 510, 515, and 520.

### System Architecture

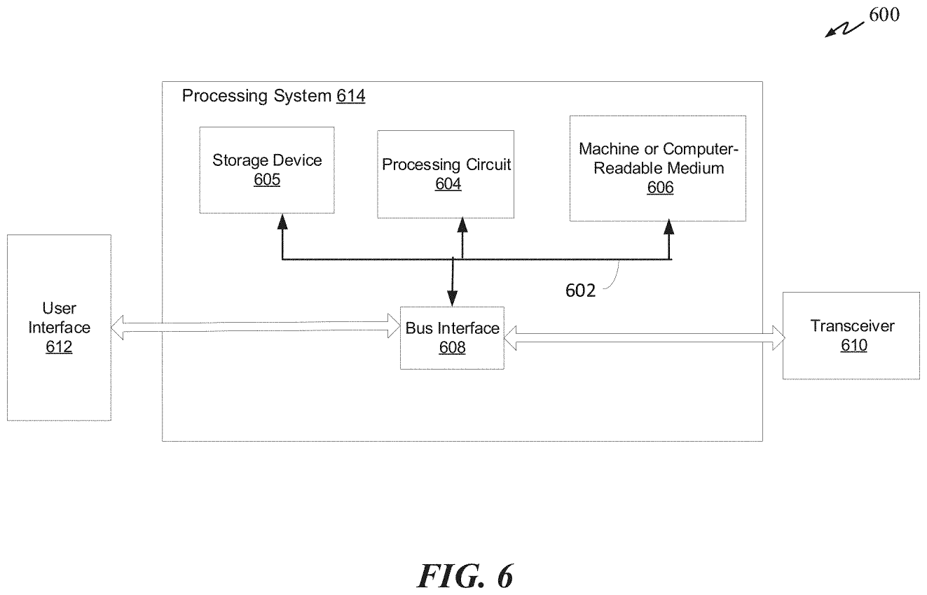

FIG. 6 illustrates an exemplary overall system or apparatus 600 in which system 100 and process 500 can be implemented. In accordance with various aspects of the disclosure, an element, or any portion of an element, or any combination of elements may be implemented with a processing system 614 that includes one or more processing circuits 604. Processing circuits 604 may include micro-processing circuits, microcontrollers, digital signal processing circuits (DSPs), field programmable gate arrays (FPGAs), programmable logic devices (PLDs), state machines, gated logic, discrete hardware circuits, and other suitable hardware configured to perform the various functionalities described throughout this disclosure. That is, the processing circuit 604 may be used to implement any one or more of the processes described above and illustrated in FIGS. 1, 2A, 2B, 3A, 3B, 4A, 4B, and 5.

In the example of FIG. 6, the processing system 614 may be implemented with a bus architecture, represented generally by the bus 602. The bus 602 may include any number of interconnecting buses and bridges depending on the specific application of the processing system 614 and the overall design constraints. The bus 602 may link various circuits including one or more processing circuits (represented generally by the processing circuit 604), the storage device 605, and a machine-readable, processor-readable, processing circuit-readable or computer-readable media (represented generally by a non-transitory machine-readable medium 609). The bus 602 may also link various other circuits such as timing sources, peripherals, voltage regulators, and power management circuits, which are well known in the art, and therefore, will not be described any further. The bus interface 608 may provide an interface between bus 602 and a transceiver 613. The transceiver 610 may provide a means for communicating with various other apparatus over a transmission medium. Depending upon the nature of the apparatus, a user interface 612 (e.g., keypad, display, speaker, microphone, touchscreen, motion sensor) may also be provided.

The processing circuit 604 may be responsible for managing the bus 602 and for general processing, including the execution of software stored on the machine-readable medium 609. The software, when executed by processing circuit 604, causes processing system 614 to perform the various functions described herein for any particular apparatus. Machine-readable medium 609 may also be used for storing data that is manipulated by processing circuit 604 when executing software.

One or more processing circuits 604 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

For example, instructions (e.g., codes) stored in the non-transitory computer readable memory, when executed, may cause the one or more processors to: segment a training data set into a plurality of segments; identify patterns within each of the plurality of segments; and generate a statistical model representing probability relationships between identified patterns.

The software may reside on machine-readable medium 609. The machine-readable medium 609 may be a non-transitory machine-readable medium. A non-transitory processing circuit-readable, machine-readable or computer-readable medium includes, by way of example, a magnetic storage device (e.g., solid state drive, hard disk, floppy disk, magnetic strip), an optical disk (e.g., digital versatile disc (DVD), Blu-Ray disc), a smart card, a flash memory device (e.g., a card, a stick, or a key drive), RAM, ROM, a programmable ROM (PROM), an erasable PROM (EPROM), an electrically erasable PROM (EEPROM), a register, a removable disk, a hard disk, a CD-ROM and any other suitable medium for storing software and/or instructions that may be accessed and read by a machine or computer. The terms “machine-readable medium”, “computer-readable medium”, “processing circuit-readable medium” and/or “processor-readable medium” may include, but are not limited to, non-transitory media such as portable or fixed storage devices, optical storage devices, and various other media capable of storing, containing or carrying instruction(s) and/or data. Thus, the various methods described herein may be fully or partially implemented by instructions and/or data that may be stored in a “machine-readable medium,” “computer-readable medium,” “processing circuit-readable medium” and/or “processor-readable medium” and executed by one or more processing circuits, machines and/or devices. The machine-readable medium may also include, by way of example, a carrier wave, a transmission line, and any other suitable medium for transmitting software and/or instructions that may be accessed and read by a computer.

The machine-readable medium 609 may reside in the processing system 614, external to the processing system 614, or distributed across multiple entities including the processing system 614. The machine-readable medium 609 may be embodied in a computer program product. By way of example, a computer program product may include a machine-readable medium in packaging materials. Those skilled in the art will recognize how best to implement the described functionality presented throughout this disclosure depending on the particular application and the overall design constraints imposed on the overall system.

One or more of the components, processes, features, and/or functions illustrated in the figures may be rearranged and/or combined into a single component, block, feature or function or embodied in several components, steps, or functions. Additional elements, components, processes, and/or functions may also be added without departing from the disclosure. The apparatus, devices, and/or components illustrated in the Figures may be configured to perform one or more of the methods, features, or processes described in the Figures. The algorithms described herein may also be efficiently implemented in software and/or embedded in hardware.

Note that the aspects of the present disclosure may be described herein as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and processes have been described above generally in terms of their functionality. Whether such functionality is implemented as hardware or software depends upon the particular application and design constraints imposed on the overall system.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the one or more processors such that the one or more processors can read information from, and write information to, the storage medium. In the alternative, the storage medium may be integral to the one or more processors.

### CONCLUSION

The enablements described above are considered novel over the prior art and are considered critical to the operation of at least one aspect of the disclosure and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described above are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

In the foregoing description and in the figures, like elements are identified with like reference numerals. The use of “e.g.,” “etc,” and “or” indicates non-exclusive alternatives without limitation, unless otherwise noted. The use of “including” or “includes” means “including, but not limited to,” or “includes, but not limited to,” unless otherwise noted.

As used above, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, processes, operations, values, and the like.

1. A method for estimating an orbit of a satellite, the method comprising:
capturing a plurality of images from a camera on the satellite;
determining a relative motion of the satellite by performing visual odometry on a first set of one or more images from the plurality of captured images;
generating loop closure measurements by comparing a second set of images from the plurality of captured images;
determining a relative geographic position of the satellite by detecting geographic anchor points of a third set of one or more images from the plurality of captured images; and
estimating, using an estimator, the orbit of the satellite based at least on one or more the determined relative motion, orbital period, and the relative geographic position of the satellite.

2. The method of claim 1, wherein estimating the orbit of the satellite comprises using a batch estimation algorithm to estimate the orbit of the satellite.

3. The method of claim 1, wherein estimating the orbit of the satellite comprises using a sequential filter algorithm to estimate the orbit of the satellite.

4. The method of claim 1, wherein determining the relative geographic position comprises performing features consistency check to omit outlying image matching correspondences

5. The method of claim 1, wherein generating loop closure measurements comprises determining at least an orbital revisit event.

6. The method of claim 1, wherein performing visual odometry comprises performing relative motion analysis on consecutives images of the first set of one or more images to determine relative motion of a satellite along a trajectory.

7. The method of claim 1, wherein determining the relative geographic position comprises map matching the third set of one or more images with geo-registered images.

8. The method of claim 1, wherein map matching comprises clustering map matches on the third set of one or more images to perform consistency check and omit outlying matches.

9. The method of claim 1, wherein the first, second, and third sets of images are identical sets of images.

10. The method of claim 1, wherein the first, second, and third sets of images are different sets of images.

11. A system for estimating an orbit of a satellite, the system comprising:
an onboard camera of the satellite configured to capture a plurality of images of surfaces of Earth;
a visual odometry module configured to determine relative motion of the satellite by performing visual odometry on a first set of one or more images captured by the onboard camera;
an orbital revisit module configured to determine loop closure metrics;
a map matching module configured to determine a relative geographic position of the satellite by detecting geographic anchor points of a third set of one or more images from the plurality of captured images; and
an orbit estimating module configured to estimate the orbit of the satellite based at least on one or more of the relative motion trajectory, loop closure metrics, and the relative geographic position of the satellite.

12. The system of claim 11, wherein the orbit estimating module is configured to use a batch estimation algorithm to estimate the orbit of the satellite.

13. The system of claim 11, wherein the map matching module is further configured to perform a consistency check of image matches by clustering and comparing image matches of images in the third set of one or more images.

14. The system of claim 11, wherein geographic features comprise one or more of coastal features, water-body features, man-made features, and terrestrial features.

15. The system of claim 11, wherein the loop closure metrics comprises one or more of a loop closure event and relative motion data of images used to detect the loop closure event.

16. The system of claim 11, wherein the visual odometry module is configured to determine relative motion using consecutives images of the first set of one or more images to determine at least a portion of a trajectory of the satellite.

17. The system of claim 11, wherein the map matching module is configured to map match features on the third set of one or more images with features on previously geo-registered images stored on an onboard database of the satellite.

18. The system of claim 11, wherein the first, second, and third sets of images are different sets of images.

19. A method for generating a 3D reconstruction map, the method comprising:
obtaining, using a simultaneous localization and mapping (SLAM) algorithm, relative motion data from a plurality of images captured from an onboard camera of a satellite;
map matching features of the plurality of captured images with features of geo-registered images to determine one or more geographic anchor points;
detecting a loop closure event based on features matching of two sets of images indicating that the satellite passed over a generally same geographic location and generating relative motion data for each of the two set of images; and
generating the 3D reconstruction map based at least on the relative motion data from the SLAM algorithm, one or more geographic anchor points, and relative motion data of the two sets of images of the loop closure event.

20. The method of claim 19, wherein map matching features further comprises performing consistency check of special features of the plurality of images.
